(19) United States
(12) Patent Application Publication
(10) Pub. No.: US 2007/0284329 A1
(43) Pub. Date: Dec. 13, 2007

(54) Quick mixing baby formula cylinder

(76) Inventors: Scott H. Hayes, Mooresville, NC (US); Scarlet L. Hayes, Mooresville, NC (US)

Correspondence Address: JAMES RAY & ASSOCIATES, 2640 Pitcairn Road, Monroeville, PA, 15146, US

(21) Appl. No.: 11/714,575

(22) Filed: Mar. 6, 2007

Related U.S. Application Data
(60) Provisional application No. 60/811,970, filed on Jun. 8, 2006.

(51) Int. Cl. A61J 11/00; A61J 9/00

(52) U.S. Cl. 215/11.1; 215/DIG. 8

(57) ABSTRACT

Baby-bottle attachment for holding dry formula separated from water in bottle having a bottom portion that has internal bottle-mating threads at a lower open end to mate to a threaded top on baby bottle. A partition having an orifice centrically located therein and a seal adhered to its upper surface is provided. Channels are partially imbedded around a portion of upper inner circumference of such bottom part. An upper chamber has an open end with external threads to mate with a nipple and a flanged partially open bottom end with an off-center aperture. A seal pad is adhered underneath a portion of the partially open bottom end. A top member has a depressible release button attached to the distal end of a strip parallel to its bottom flange and extending from the proximal end attached to outer surface near bottom of the upper cup-like chamber. The final essential element is a bolt and nut assembly having a sealing washer attached to a flat surface of such nut.

### CROSS REFERENCE TO RELATED APPLICATION

This patent application is related to and claims priority from U.S. Provisional Patent Application Ser. No. 60/811,970 filed Jun. 8, 2006.

### FIELD OF THE INVENTION

The present invention relates, in general, to baby formula bottles and, more particularly, this invention relates to an improved method for transporting and quickly mixing dry formula and water in the proper ratio to prepare a ready-to-drink bottle in travel situations.

### BACKGROUND OF THE INVENTION

Prior to the conception and development of the present invention, powder baby formula is typically measured in proper ratio to the amount of water in the bottle and then immediately added to the water and mixed just minutes prior to consumption. This approach presents no difficulty at home, but it does impose an inconvenience to the parents or caregivers while traveling. In fact, use of liquid formulas is more prevalent at home. Infants require frequent feeding and liquid formula bottles or milk require refrigeration to prevent spoilage, and heating is required prior to consumption. While the refrigeration and heating can be avoided by blending a powder and water just prior to consumption, this poses an inconvenience and potentially messy situation while traveling.

Numerous, somewhat elaborate, devices have been disclosed for storing a formula powder within a bottle until just prior to consumption, with provisions for rapidly combining and mixing the liquid and powder without opening the bottle. Some represent a whole new bottle design while others are made to fit into a standard bottle arrangement.

For example, in U.S. Pat. No. 5,419,445, Kaesemeyer teaches the design of holding the formula powder in a cartridge inside a baby bottle with the water stored in the bottle below.

In U.S. Pat. No. 5,794,802, Caola teaches a reusable insert designed for standard baby bottles to keep the formula powder and water separate until a push rod forces a chamber seal into the water portion of the bottle. Activation in this case involves the unsanitary act of pushing on the nipple.

In U.S. Pat. No. 5,634,714 to Guild, a long-stemmed disk is dislodged and falls into the liquid allowing the powder to mix with the water.

One common and significant feature of these three examples and others is that a portion of the sealing mechanism is pushed into the lower water compartment at the time of mixing, and it must be retrieved and reassembled later. Thus, it appears that there is a need for a moderately-priced convenience device that fits standard bottle/nipple combinations, yet avoids the retrieval and reassembly tasks.

### SUMMARY OF THE INVENTION

A cylindrical baby-bottle attachment for holding dry feeding formula separate from water in the bottle having a cylindrical bottom part that has at least one U-shaped recess in the top rim and includes internal bottle-mating threads at a lower first totally open end sized to mate to a threaded top on a common baby bottle. A midsection partition covers at least half of the cylinder cross sectional area. This partition has an orifice at the center axis for a bolt and also has a rubber-like seal pad adhered to a solid portion of its upper surface. There are channels partially imbedded around a substantial portion of the upper inner circumference of such bottom part. Further, there is an upper cup-like chamber having a totally open top end with external threads sized to accommodate a common nipple assembly further having a flanged partially open bottom end with an off-center aperture. The aperture has a cross sectional area about 0.2 to 0.5 that of the total cross sectional area and there is a seal pad adhered underneath a solid portion of the partially open bottom end which has a cross sectional area at least as great as that of the apertures. The top member further has at least one outward-facing depressible release button attached to the distal end of a rectangular strip parallel to its bottom flange and extending tangentially from proximal end attached to outer surface near the bottom of the upper cup-like chamber. The final essential element is a bolt and matching wing nut assembly with the bolt fused to the bottom floor and the wing nut further having a sealing washer attached to a flat surface on one side of such wing nut. The present invention provides a convenient and economical device for storing and subsequently mixing a pre-measured amount of baby formula powder with water in a feeding bottle. It is especially convenient for times when traveling with an infant.

### OBJECTS OF THE INVENTION

It is, therefore, one of the primary objects of the present invention to provide a convenient and economical device that will simplify transportation and eventual mixing of powdered infant formula with water just prior to consumption.

Another object of the present invention is to provide an attachment fitting many current commercial bottles and nipples such that the parents will have an economical total unit without replacing their current bottle supply.

An additional object of this invention is to provide a infant bottle attachment that is reusable without retrieving parts and putting them back together.

In addition to the various objects and advantages of the present invention described with some degree of specificity above it should be obvious that additional objects and advantages of the present invention will become more readily apparent to those persons who are skilled in the relevant art from the following more detailed description of the invention, particularly, when such description is taken in conjunction with the attached drawing figures and with the appended claims.

### BRIEF DESCRIPTION OF THE DRAWINGS

FIG. 1 is an overview of an infant feeding bottle unit with the cylinder invention assembled between the bottle and nipple.

FIG. 2 is a perspective view of the upper chamber of the cylinder attachment.

FIG. 3 is a perspective view of the upper chamber being held by a lower mounting ring to the top of a standard plastic baby bottle.

FIG. 4 is an elevation sectional view of the formula cylinder apparatus.

FIG. 5 is an elevation sectional view of a second embodiment of the invention.

FIG. 6 is a perspective view of the second embodiment of the invention.

FIG. 7 is an elevation sectional view of a third embodiment of the invention.

### DESCRIPTION OF A PRESENTLY PREFERRED AND VARIOUS ALTERNATIVE EMBODIMENTS OF THE INVENTION

Prior to proceeding to the more detailed description of the present invention it should be noted that, for the sake of clarity and understanding, identical components which have identical functions have been identified with identical reference numerals throughout the several views illustrated in the drawing figures.

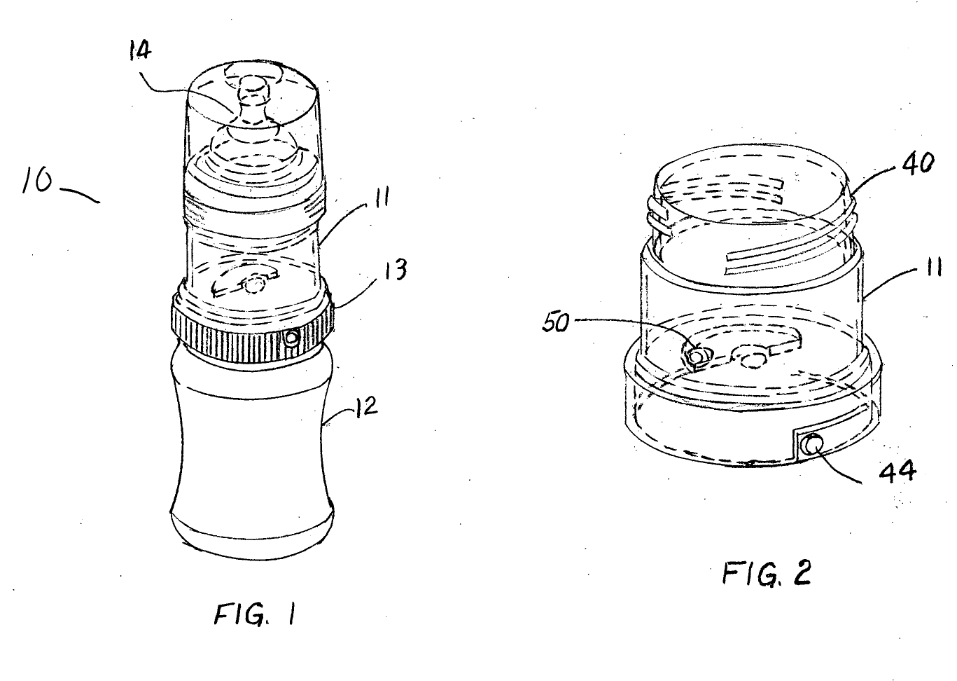

Referring initially to FIG. 1, a bottle and formula cylinder arrangement, generally designated 10, is shown with a cylinder 11 attached to a standard baby bottle 12 below via the lower ring 13, and also attached to a standard nipple and cover assembly 14 above. As shown in FIG. 2 the upper cylinder 11 includes the upper aperture 50, the release button 44, and the nipple mating threads 40.

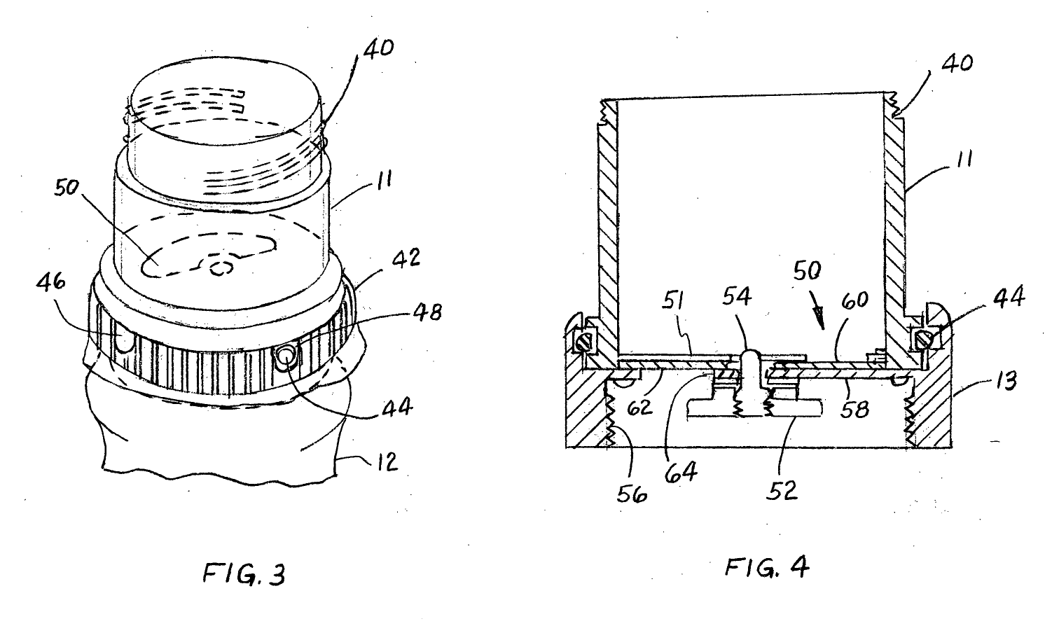

Referring to FIG. 3, the preferred embodiment of the invention is depicted mounted on the top of a standard baby bottle 12. A cylindrical chamber 11 holds and keeps the powder dry until a release button 44 is depressed at “Closed” notch 46 in bottom ring 42 allowing the cylinder 11 to be rotated to “Open” position 48, whereupon button 44 is released. This rotation aligns the aperture 50 with an aperture of similar size and shape in a horizontal partition across the open area of a ring 42. Mating thread 40 are available for screwing on a standard nipple assembly.

FIG. 4 provides a vertical sectional view of a two-button version of the presently preferred embodiment with additional construction details. The upper chamber 11 is connected to the bottom ring 42 by the combination of a bolt 54 fused to the bottom 51 at the central axis and a nut 52 screwed onto bolt 54 beneath the horizontal partition 58 that is integral to ring 42. There are comparable apertures 50 in the bottom floor 51 and 64 in the horizontal partition 58. When in the Closed position, the two apertures are sealed by rubber like pads 60 and 62 of slightly larger size adhered to a solid surface of the opposing partitions, 58 and 51 respectively.

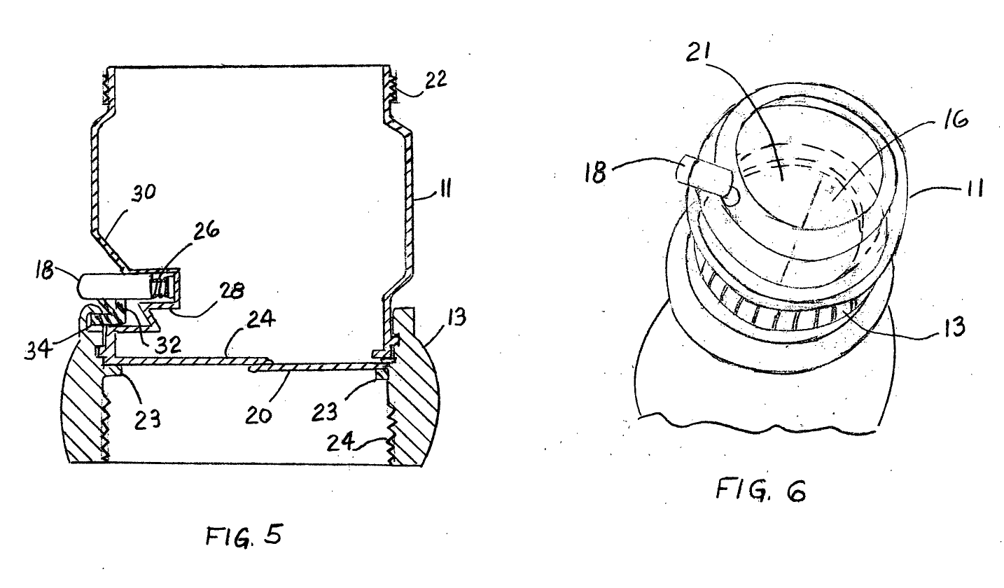

FIG. 5 is a vertical sectional view of a second embodiment cutting through the release button 18 longitudinally, and showing both the upper cylinder 11 with its nipple mating threads 22, and the lower attachment ring 13. Above the bottle mating threads 24, the lower ring 13 has a built-in horizontal member 20 that covers about half of the cross section area defined by the inside diameter of ring 13. Also built into the upper inside surface of attachment ring 13 are a circumferential ledge 23, a circumferential groove 25, and a cavity 34. Release button 18 has an attached leg 32 that engages with cavity 34. Also attached to button 18 is a spring 26 that fits into the cavity 28 molded into recessed area 30 of the upper cylinder 11. The cylinder 11 has a floor 21 across slightly more than half of the bottom area.

FIG. 6 is a perspective view from above with the two apertures aligned to create an opening 16. When the user desires to blend the formula powder stored in cylinder 11 with the water in the bottle 12, the release button 18 is depressed and held in while rotating the upper cylinder 11 approximately 180 degrees until the floor 21 is in position to create the opening 16 that will readily allow the powder to drop and be mixed with the water. The opening 16 remains while the prepared formula is fed to the infant.

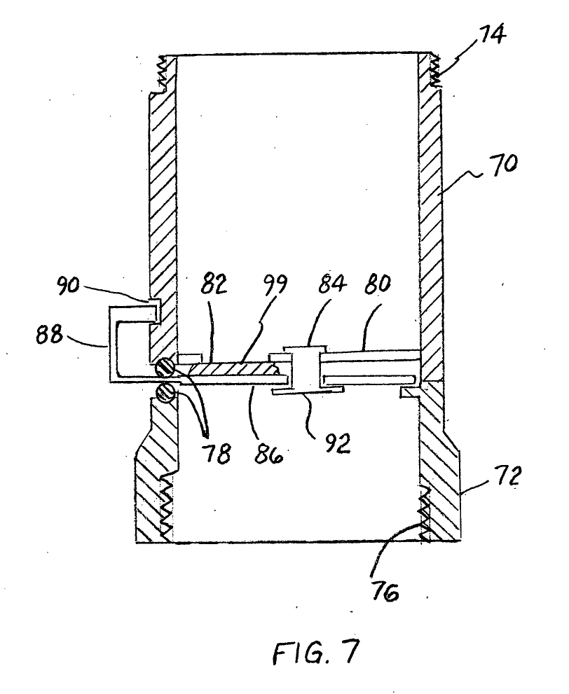

A third embodiment of the invention is shown in FIG. 7 via a vertical sectional view of the device. The upper cylindrical chamber 70 having external threads adjacent the top end, for mating to a standard baby bottle nipple, is fused at three-quarters of its bottom periphery, to lower ring 72, which has internal threads 76 to mate to a standard baby bottle. Where the other one quarter of the bottom edge of cylindrical chamber 70 abuts the top edge of ring 72. Rubber-like partial O-rings 78 are imbedded in the edge such that the two partial O-rings 78 are tightly compressed against one another. The cylindrical chamber 70, has a bottom floor 80 with a sizeable off-center aperture 82 and a central fused-in pin 84.

Suspended just below the bottom floor 80 is a rotatable horizontal disc 86 with a central orifice slightly larger than the outer diameter of central pin 84. Adhered to the top surface of disc 86 is a rubber-like seal pad 94 covering an area slightly larger than that of aperture 82. Horizontal disc 86 is held in place on central pin 84 by a fused on washer 92 such that disc 86 is still free to rotate while seal pad 94 is held against the underside of floor 80 sufficiently to prevent water leakage past it. Disc 86 also has an off-center aperture comparable in size and shape to aperture 82, and this aperture in disc 86 is centered about 90 degrees from seal pad 94.

A substantially U-shaped tab 88 is fused at one location on the periphery of disc 86 and extends outward between O-rings 78 with the distal end engaging one of two notches 90 built into the outer surface of cylindrical chamber 70. When in the closed position, seal pad 94 covers the floor aperture 82 and disc 86 is prevented from rotating by tab 88 engaged in a notch 90.

When the user wishes to mix the two ingredients, the tab 88 is pulled back to release it from the “Closed” notch, and tab 88 is then slid about 90 degrees and released into the “Open” notch. This aligns the two apertures and allows the powder to drop into the water and be mixed by shaking. The “Open” position is maintained for feeding the baby.

While a presently preferred and various alternative embodiments of the present invention have been described in sufficient detail above to enable a person skilled in the relevant art to make and use the same, it should be obvious that various other adaptations and modifications can be envisioned by those persons skilled in such art without departing from either the spirit of the invention or the scope of the appended claims.

We claim:

1. A cylindrical baby-bottle attachment comprising:
(a) a cylindrical bottom part with each of a first predetermined outside diameter and a first predetermined height defining a lower first totally open end and an upper second open end, said upper second open end defining a first predetermined cross sectional area including:
(i) internal bottle-mating threads at said lower first totally open end sized to mate to a threaded top on a common baby bottle;
(ii) a horizontal midsection partition perpendicular to inside wall of said bottom cylinder above said threads and covering at least half of said predetermined cross sectional area;
(iii) a rubber-like seal pad adhered to a solid portion of upper surface of said midsection partition, said midsection partition further having an orifice at the center axis for a bolt;
(iv) channels partially imbedded around a substantial portion of upper inner circumference of said bottom part;
(v) at least one U-shaped recess in top rim of said bottom part; and
(b) an upper cup-like chamber with each of a second predetermined height and a second predetermined cross sectional area including:
(i) a partially open bottom end with an off-center aperture having a third cross sectional area about 0.2 to 0.5 that of said second predetermined cross sectional area;
(ii) a second totally open top end, said second totally open top end having external threads sized to accommodate a common nipple assembly;
(iii) a seal pad adhered underneath a solid portion of said partially open bottom end and having a fourth cross sectional area at least as great as that of said third cross sectional area;
(iv) a bottom outward-protruding flange molded into lower outer surface of said cup-like chamber;
(v) at least one outward-facing depressible release button attached to a distal end of a rectangular strip parallel to said bottom outward-protruding flange and extending tangentially from proximal end attached to outer surface of said upper cup-like chamber;
(d) a bolt and matching wing nut assembly, said bolt fused to said bottom of said partially open bottom end, said wing nut further having a slidable sealing washer attached to a flat surface on one side of said wing nut; and
(e) a sealing gasket attached to the underside of said midsection partition adjacent a proximal end of said bottle mating threads.

2. A cylindrical baby bottle attachment, according to claim 1, wherein said first predetermined diameter of said cylindrical bottom part is between about 1.5 and 3.0 inches.

3. A cylindrical baby bottle attachment, according to claim 1, wherein, said first predetermined height of said cylindrical bottom part is between about 0.5 and 2.0 inches.

4. A cylindrical baby bottle attachment, according to claim 1, wherein, said second predetermined height of said upper cup-like chamber is between about 2.0 and 4.0 inches.

5. A cylindrical baby-bottle attachment comprising:
(a) a hoop-like bottom part having a first predetermined height and a first predetermined outer diameter defining a first partially open top end and a first totally open lower end, said totally open lower end having internal threads sized to mate to a threaded top on a baby bottle, said first partially open end has at least one mating cavity within uppermost internal surface and a groove formed around an upper inner circumference beneath said cavity, said partially open end further has an internal flange protruding toward a center axis extending along at least half of an internal circumference; and
(b) an upper cup-like chamber having a second predetermined height and a second predetermined central diameter and a third predetermined base diameter including:
(i) a lower second partially-open end and a second totally-open top end, said second totally open end having external threads sized to accommodate a baby bottle nipple assembly;
(ii) a semi-circular aperture having an open area about one-third to about half that of entire cross section of said partially-closed end;
(iii) at least one beveled recessed zone proximal said second partially open end; and
(iv) a cavity within each said beveled recessed zone extending radially toward the central axis;
(c) at least one spring-loaded release button assembly positioned in each of said beveled recessed zones of said upper cup-like chamber, wherein each of said release buttons has an L-shaped foot engaging with each of said cavities in said hoop-like bottom part; and
(d) a rubber-like O-ring seal attached to an upper surface of said flange inside said hoop-like bottom part for about half of said inner circumference.

6. A baby-bottle attachment, according to claim 4, wherein said first height of said hoop-like bottom part is between about 0.75 to 2.0 inches.

7. A baby-bottle attachment, according to claim 5, wherein said first predetermined outside diameter of said hoop-like bottom part is between about 2.0 and 3.5 inches

8. A baby-bottle attachment according to claim 5, wherein said second predetermined height of said upper cup-like chamber is between about 2.0 inches and 4.0 inches.

9. A baby-bottle attachment, according to claim 5, wherein said second predetermined central diameter of said upper cup-like chamber is between about 2.0 and 3.5 inches.

10. A baby-bottle attachment, according to claim 5, wherein said third predetermined base diameter of said upper cup-like chamber is between about 1.5 and 3.5 inches

11. A cylindrical baby-bottle attachment made of inseparable parts comprising:
(a) a cylindrical bottom part defining two substantially open ends with a first predetermined height, wherein a lower of said two substantially open ends contains internal threads sized to mate with those of a baby bottle;
(b) a partial O-ring is embedded in about one-quarter of top rim.
(c) an upper cylindrical chamber with a second predetermined second height and each of a totally open upper end and a partially open floor, including:
(i) external threads at top of said totally open end sized to mate to those of a baby bottle nipple assembly,
(ii) a downward-projecting pin at center axis fused to said partially open floor,
(iii) an off-center aperture in said partially open floor creating an open area between about 0.2 to 0.5 that of total area of said partially open floor,
(iv) a partial O-ring embedded along about one quarter of bottom rim of said upper cylindrical chamber,
(c) a horizontal revolving disc suspended beneath said floor of said upper cylindrical chamber, including:
(i) a rubber-like seal pad adhered to an upper surface of said revolving disc and having a similar shape to said aperture in said partially open floor of said upper cylindrical chamber;
(ii) an off-center aperture comparable in area and shape to that of said aperture in said partially open floor,
(iii) a central orifice of slightly greater diameter than that of said downward projecting pin, and
(d) one of a washer and a nut fused to lower end of said downward projecting pin beneath said revolving disc.

12. A cylindrical baby bottle attachment of claim 11, wherein said first predetermined height of said cylindrical bottom part is between about 0.75 and 2.0 inches.

13. The cylindrical baby bottle attachment of claim 11, wherein said second predetermined height of said upper cylindrical chamber is between about 2.0 and 4.0 inches.
